(19) United States
(12) Patent Application Publication
(10) Pub. No.: US 2024/0027826 A1
(43) Pub. Date: Jan. 25, 2024

(54) INTELLIGENT REFLECTING SURFACE

(71) Applicant: Japan Display Inc., Tokyo (JP)

(72) Inventors: Mitsutaka OKITA, Tokyo (JP); Shinichiro OKA, Tokyo (JP); Shigesumi ARAKI, Tokyo (JP); Daiichi SUZUKI, Tokyo (JP); Yoshiaki AMANO, Fujimino-shi (JP); Hiromi MATSUNO, Fujimino-shi (JP)

(73) Assignee: Japan Display Inc., Tokyo (JP)

(21) Appl. No.: 18/477,550

(22) Filed: Sep. 29, 2023

Related U.S. Application Data
(63) Continuation of application No. PCT/JP2022/005130, filed on Feb. 9, 2022.

(30) Foreign Application Priority Data
Mar. 31, 2021 (JP) 2021-060858

(51) Int. Cl. G02F 1/1335; G02F 1/1347; G02F 1/1343

(52) U.S. Cl. CPC G02F 1/133553; G02F 1/13478; G02F 1/134309

(57) ABSTRACT

According to one embodiment, an intelligent reflecting surface includes a first substrate including a plurality of patch electrodes spaced apart and arranged in a matrix along each of an X-axis and a Y-axis orthogonal to each other, a second substrate including a common electrode opposed to the plurality of patch electrodes in a direction parallel to a Z-axis orthogonal to each of the X-axis and the Y-axis, and a liquid crystal layer held between the first substrate and the second substrate and opposed to the plurality of patch electrodes. Each of the patch electrodes includes a first aperture.

### CROSS-REFERENCE TO RELATED APPLICATIONS

This application is a Continuation Application of PCT Application No. PCT/JP2022/005130, filed Feb. 9, 2022 and based upon and claiming the benefit of priority from Japanese Patent Application No. 2021-060858, filed Mar. 31, 2021, the entire contents of all of which are incorporated herein by reference.

### FIELD

Embodiments described herein relate generally to an intelligent reflecting surface.

### BACKGROUND

Studying intelligent reflecting surfaces capable of controlling a direction of radio wave reflection using liquid crystal has been performed. On this intelligent reflecting surface, reflection controllers including reflecting electrodes are arranged one-dimensionally (or two-dimensionally). On the intelligent reflecting surface, the dielectric constant of the liquid crystal also needs to be adjusted such that a phase difference of the reflected radio waves is constant between the adjacent reflection controllers.

Embodiments described herein aim to provide an intelligent reflecting surface capable of increasing an amount of phase change in the reflected waves of radio waves.

### BRIEF DESCRIPTION OF THE DRAWINGS

FIG. 1 is a cross-sectional view showing an intelligent reflecting surface according to an embodiment.

FIG. 2 is a plan view showing the intelligent reflecting surface shown in FIG. 1.

FIG. 3 is an enlarged plan view showing a patch electrode shown in FIG. 1 and FIG. 2.

FIG. 4 is an enlarged cross-sectional view showing a part of the intelligent reflecting surface, illustrating a single reflection controller.

FIG. 5 is an enlarged cross-sectional view showing a part of the intelligent reflecting surface, illustrating a plurality of reflection controllers.

FIG. 6 is a timing chart showing changes in the voltage applied to the patch electrode for each period in a method for driving the intelligent reflecting surface of the embodiment.

FIG. 7 is a bar graph showing amounts of the phase change in reflected waves in the embodiment and a comparative example.

FIG. 8 is a bar graph showing amounts of attenuation in reflected waves in the embodiment and the comparative example.

FIG. 9 is an enlarged plan view showing a plurality of patch electrodes and a plurality of connection wires according to modified example 1 of the embodiment.

FIG. 10 is an enlarged plan view showing a plurality of patch electrodes and a plurality of connection wires according to modified example 2 of the embodiment.

FIG. 11 is an enlarged plan view showing a part of the intelligent reflecting surface according to modified example 3 of the embodiment, illustrating a plurality of patch electrodes, a plurality of connection wires, and a common electrode.

FIG. 12 is an enlarged cross-sectional view showing a part of the intelligent reflecting surface according to modified example 3, illustrating a single reflection controller.

### DETAILED DESCRIPTION

In general, according to one embodiment, there is provided an intelligent reflecting surface comprising: a first substrate including a plurality of patch electrodes spaced apart and arranged in a matrix along each of an X-axis and a Y-axis orthogonal to each other; a second substrate including a common electrode opposed to the plurality of patch electrodes in a direction parallel to a Z-axis orthogonal to each of the X-axis and the Y-axis; and a liquid crystal layer held between the first substrate and the second substrate and opposed to the plurality of patch electrodes, each of the patch electrodes including a first aperture.

According to another embodiment, there is provided an intelligent reflecting surface comprising: a first substrate including a plurality of patch electrodes spaced apart and arranged in a matrix along each of an X-axis and a Y-axis orthogonal to each other; a second substrate including a common electrode opposed to the plurality of patch electrodes in a direction parallel to a Z-axis orthogonal to each of the X-axis and the Y-axis; and a liquid crystal layer held between the first substrate and the second substrate and opposed to the plurality of patch electrodes, the common electrode including a plurality of first apertures, each of the first apertures overlapping with one corresponding patch electrode among the plurality of patch electrodes.

Embodiments will be described hereinafter with reference to the accompanying drawings. The disclosure is merely an example, and proper changes within the spirit of the invention, which are easily conceivable by a person of ordinary skill in the art, are included in the scope of the invention as a matter of course. In addition, in some cases, in order to make the description clearer, the widths, thicknesses, shapes and the like, of the respective parts are schematically illustrated in the drawings, compared to the actual modes. However, the schematic illustration is merely an example, and adds no restriction to the interpretation of the invention. Besides, in the specification and drawings, the same elements as those described in connection with preceding drawings are denoted by like reference numbers, and a detailed description thereof is omitted unless necessary.

### Embodiment

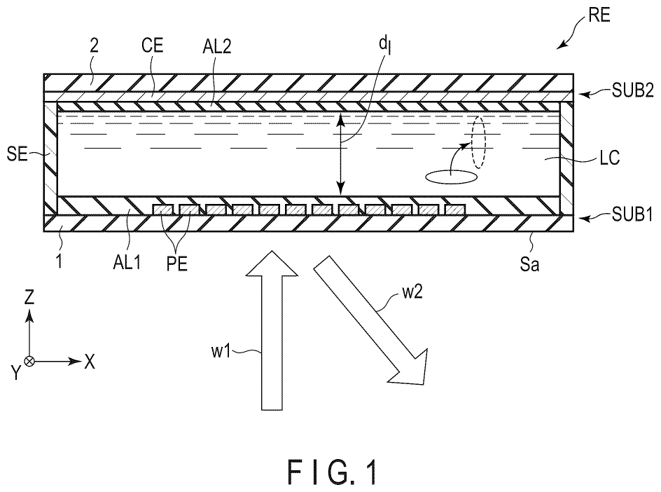

First, an embodiment will be described. FIG. 1 is a cross-sectional view showing an intelligent reflecting surface RE according to the embodiment. The intelligent reflecting surface RE can reflect radio waves and functions as a relay device for radio waves.

As shown in FIG. 1, the intelligent reflecting surface RE comprises a first substrate SUB1, a second substrate SUB2, and a liquid crystal layer LC. The first substrate SUB1 includes an electrically insulating substrate 1, a plurality of patch electrodes PE, and an alignment film AL′. The substrate 1 is formed in a flat plate shape and extends along an X-Y plane including an X-axis and a Y-axis orthogonal to each other. The alignment film AL1 covers the plurality of patch electrodes PE.

The second substrate SUB2 is opposed to the first substrate SUB1 with a predetermined gap. The second substrate SUB2 includes an electrically insulating substrate 2, a common electrode CE, and an alignment film AL2. The substrate 2 is formed in a flat plate shape and extends along the X-Y plane. The common electrode CE is opposed to the plurality of patch electrodes PE in a direction parallel to the Z-axis orthogonal to each of the X-axis and Y-axis. The alignment film AL2 covers the common electrode CE. In the embodiment, each of the alignment film AL1 and the alignment film AL2 is a horizontal alignment film.

The first substrate SUB1 and the second substrate SUB2 are joined by a sealing material SE arranged on their respective peripheral portions. The liquid crystal layer LC is provided in a space surrounded by the first substrate SUB1, the second substrate SUB2 and the sealing material SE. The liquid crystal layer LC is held between the first substrate SUB1 and the second substrate SUB2. The liquid crystal layer LC is opposed to the plurality of patch electrodes PE on the one hand and to the common electrode CE on the other hand.

A thickness (cell gap) of the liquid crystal layer LC is referred to as dₗ. The thickness dₗ is greater than a thickness of the liquid crystal layer of a normal liquid crystal display panel. In the embodiment, the thickness dₗ is 50 μm. However, the thickness dₗ may be less than 50 μm as long as the reflection phase of radio waves can be sufficiently adjusted. Alternatively, the thickness dₗ may exceed 50 μm in order to increase the reflection angle of radio waves. The liquid crystal material used for the liquid crystal layer LC of the intelligent reflecting surface RE is different from the liquid crystal material used for ordinary liquid crystal display panels. The above-described reflection phase of the radio waves will be described later.

A common voltage is applied to the common electrode CE, and the potential of the common electrode CE is fixed. In the embodiment, the common voltage is V. A voltage is also applied to the patch electrodes PE. In the embodiment, the patch electrodes PE are AC-driven. The liquid crystal layer LC is driven by a so-called longitudinal electric field. A voltage applied between the patch electrodes PE and the common electrode CE acts on the liquid crystal layer LC, thereby changing the dielectric constant of the liquid crystal layer LC.

When the dielectric constant of the liquid crystal layer LC changes, the propagation speed of radio waves in the liquid crystal layer LC also changes. Therefore, the reflection phase of radio waves can be adjusted by adjusting the voltage applied to the liquid crystal layer LC. As a result, the reflection direction of radio waves can be adjusted. In the embodiment, an absolute value of the voltage applied to the liquid crystal layer LC is 10 V or less. This is because the dielectric constant of the liquid crystal layer LC is saturated at 10 V. However, since the voltage at which the liquid crystal layer LC is saturated varies depending on the dielectric constant of the liquid crystal layer LC, the absolute value of the voltage acting on the liquid crystal layer LC may exceed 10 V. For example, when improvement of the response speed of the liquid crystal is required, a voltage of 10 V or less may be applied to the liquid crystal layer LC after a voltage exceeding 10 V is applied to the liquid crystal layer LC.

The first substrate SUB1 has an incident surface Sa on the side opposite to the side opposed to the second substrate SUB2. In the figure, an incident wave w1 is a radio wave made incident on the intelligent reflecting surface RE, and a reflected wave w2 is a radio wave reflected on the intelligent reflecting surface RE.

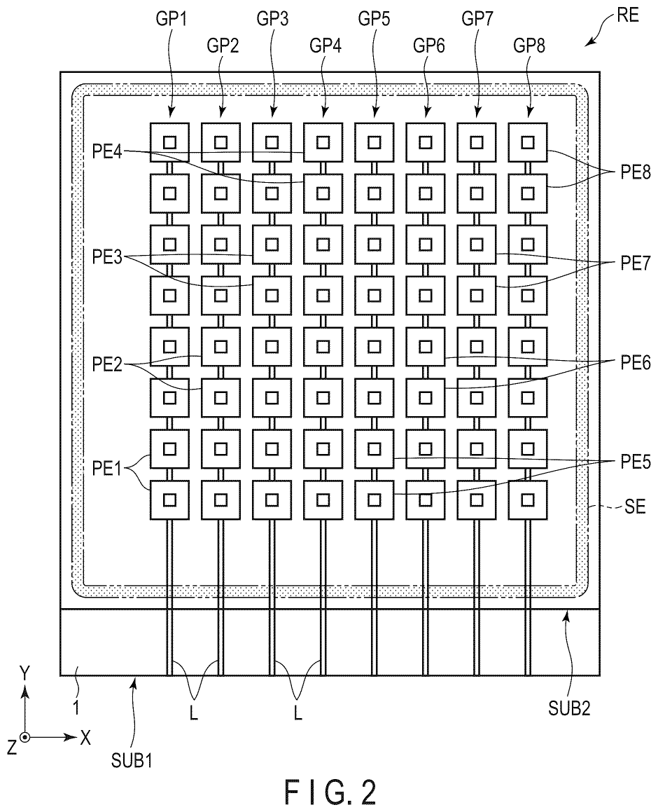

FIG. 2 is a plan view showing the intelligent reflecting surface RE shown in FIG. 1. As shown in FIG. 2, the plurality of patch electrodes PE are arranged in a matrix at intervals along each of the X-axis and the Y-axis. On the X-Y plane, the plurality of patch electrodes PE have the same shape and the same size.

The plurality of patch electrodes PE are arranged at regular intervals along the X-axis and arranged at regular intervals along the Y-axis. The plurality of patch electrodes PE are included in a plurality of patch electrode groups GP extending along the Y-axis and arranged along the X-axis. The plurality of patch electrode groups GP include a first patch electrode group GP1 to an eighth patch electrode group GP8.

The first patch electrode group GP1 includes a plurality of first patch electrodes PE1, the second patch electrode group GP2 includes a plurality of second patch electrodes PE2, the third patch electrode group GP3 includes a plurality of third patch electrodes PE3, the fourth patch electrode group GP4 includes a plurality of fourth patch electrodes PE4, the fifth patch electrode group GP5 includes a plurality of fifth patch electrodes PE5, the sixth patch electrode group GP6 includes a plurality of the six patch electrodes PE6, the seventh patch electrode group GP7 includes a plurality of seventh patch electrodes PE7, and the eighth patch electrode group GP8 includes a plurality of eighth patch electrodes PE8. For example, the second patch electrode PE2 is located between the first patch electrode PE1 and the third patch electrode PE3 in the direction along the X-axis.

Each patch electrode group GP includes a plurality of patch electrodes PE arranged along the Y-axis and electrically connected to each other. In the embodiment, the plurality of patch electrodes PE of each patch electrode group GP are electrically connected by connection wires L. The first substrate SUB1 includes the plurality of connection wires L extending along the Y-axis and arranged along the X-axis. The connection wires L extend to an area of the substrate 1, which is not opposed to the second substrate SUB2. Unlike the present embodiment, the plurality of connection wires L may be connected to the plurality of patch electrodes PE in one-to-one relationship.

In the embodiment, the plurality of patch electrodes PE arranged along the Y-axis and the connection wires L are integrally formed of the same conductor. The plurality of patch electrodes PE and the connection wires L may be formed of conductors different from each other. The patch electrodes PE, the connection wires L, and the common electrode CE are formed of metal or a conductor similar to metal. For example, the patch electrodes PE, the connection wires L, and the common electrode CE may be formed of a transparent conductive material such as indium tin oxide (ITO). The connection wires L may be connected to an outer lead bonding (OLB) pad (not shown).

The connection wire L is a fine wire, and a width of the connection wire L is sufficiently smaller than a length Px which will be described later. The width of the connection wire L is several μm to several tens of μm, and is on the order of μm. If the width of the connection wire L is made too large, the sensitivity to the frequency component of the radio waves is changed, which is not desirable.

The sealing material SE is arranged at a peripheral edge of the area where the first substrate SUB1 and the second substrate SUB2 are opposed to each other.

FIG. 2 shows an example in which eight patch electrodes PE are arranged in the direction along the X-axis and in the direction along the Y-axis. However, the number of patch electrodes PE can be variously modified. For example, hundred patch electrodes PE may be arranged in the direction along the X-axis, and a plurality of (for example, hundred) patch electrodes PE may be arranged in the direction along the Y-axis. The length of the intelligent reflecting surface RE (first substrate SUB1) in the X-axis direction is, for example, 40 to 80 cm.

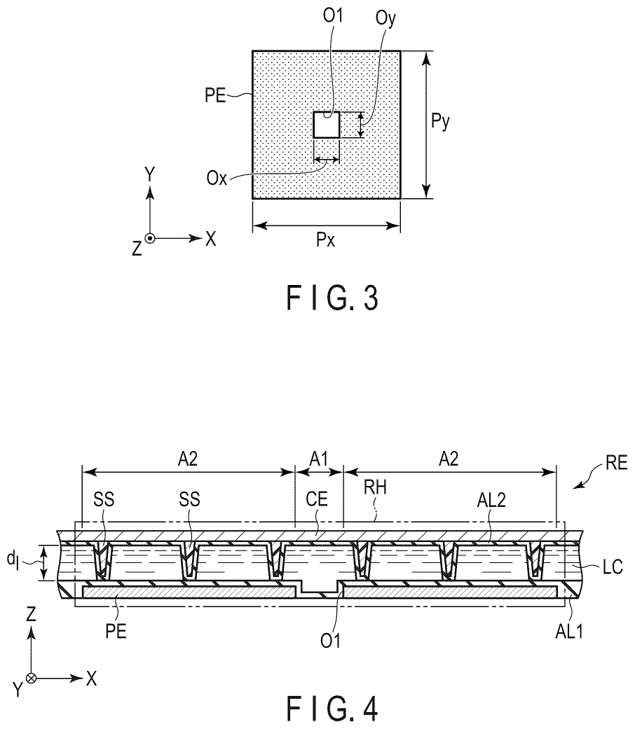

FIG. 3 is an enlarged plan view showing the patch electrode PE shown in FIG. 1 and FIG. 2. As shown in FIG. 3, the patch electrode PE has a square shape. Although the shape of the patch electrode PE is not particularly limited, a square or a perfect circle is desirable. When the external shape of the patch electrode PE is focused, a shape with a vertical and horizontal aspect ratio of 1:1 is desirable. This is because a 90° rotationally symmetrical structure is desirable to respond to a horizontally polarized wave and a vertically polarized wave.

The patch electrode PE has a length Px along the X-axis and a length Py along the Y-axis. The length Px and the length Py are desirably adjusted according to the frequency range of the incident wave w1. Next, a desirable relationship between the frequency range of the incident wave w1 and the lengths Px and Py will be illustrated.

2.4 GHz:Px=Py=35 mm

5.0 GHz:Px=Py=16.8 mm

28 GHz:Px=Py=3.0 mm

The patch electrode PE has a hole referred to as an aperture. In the embodiment, each patch electrode PE includes a single first aperture O1. In the embodiment, the first aperture O1 has a quadrangular (square) shape. The first aperture O1 has a length Ox in a direction along the X-axis and a length Oy in a direction along the Y-axis. Each of the length Ox and the length Oy is 100 μm to several 100 μm.

The plurality of patch electrodes PE will be focused.

As shown in FIG. 2 and FIG. 3, the size and shape of the first aperture O1 are the same among the plurality of patch electrodes PE. A relative position of the first aperture O1 in the patch electrode PE is the same among the plurality of patch electrodes PE. FIG. 4 is an enlarged cross-sectional view showing a part of the intelligent reflecting surface RE, illustrating a single reflection controller RH. In FIG. 4, illustration of the substrate 1 and the like is omitted.

As shown in FIG. 4, a thickness dₗ (cell gap) of the liquid crystal layer LC is maintained by a plurality of spacers SS. In the embodiment, the spacers SS are columnar spacers, formed in the second substrate SUB2, and protruding toward the first substrate SUB1 side. No spacer SS exists in an area opposed to the first aperture O1.

A cross-sectional diameter of the spacer SS in the X direction is 10 to 20 μm. While the length Px and the length Py of the patch electrode PE are on the order of mm, the cross-sectional diameter of the spacer SS in the X direction is on the order of μm. For this reason, the spacers SS need to exist in the areas opposed to the patch electrode PE. In addition, a ratio of the areas where the plurality of spacers SS exist, of the areas opposed to the patch electrodes PE is approximately 1%.

For this reason, even if the spacers SS exist in the above areas, the effect of the spacers SS on the reflected wave w2 is small. The spacers SS may be formed in the first substrate SUB1 and protrude toward the second substrate SUB2 side. Alternatively, the spacers SS may be spherical spacers.

In addition, unlike the embodiment, the spacers SS may exist in the areas opposed to the first aperture O1.

The intelligent reflecting surface RE comprises a plurality of reflection controllers RH. Each reflection controller RH includes one patch electrode PE among the plurality of patch electrodes PE, a portion of the common electrode CE, which is opposed to the one patch electrode PE, a first area A1 of the liquid crystal layer LC, and a second area A2 of the liquid crystal layer LC. The first area A1 is an area opposed to the first aperture O1 of one patch electrode PE in the liquid crystal layer LC. The second area A2 is an area opposed to one patch electrode PE in the liquid crystal layer LC and an area surrounding the first area A1.

In a state in which no voltage is applied between the patch electrode PE and the common electrode CE, the dielectric constant of the first area A1 is the same as the dielectric constant of the second area A2. When a voltage is applied between the patch electrode PE and the common electrode CE, the dielectric constant of the first area A1 does not substantially change, but the dielectric constant of the second area A2 changes. The dielectric constant of the liquid crystal layer LC is proportional to the voltage applied between the patch electrode PE and the common electrode CE. For this reason, in a state in which a voltage is applied between the patch electrode PE and the common electrode CE, the dielectric constant of the first area A1 is different from the dielectric constant of the second area A2.

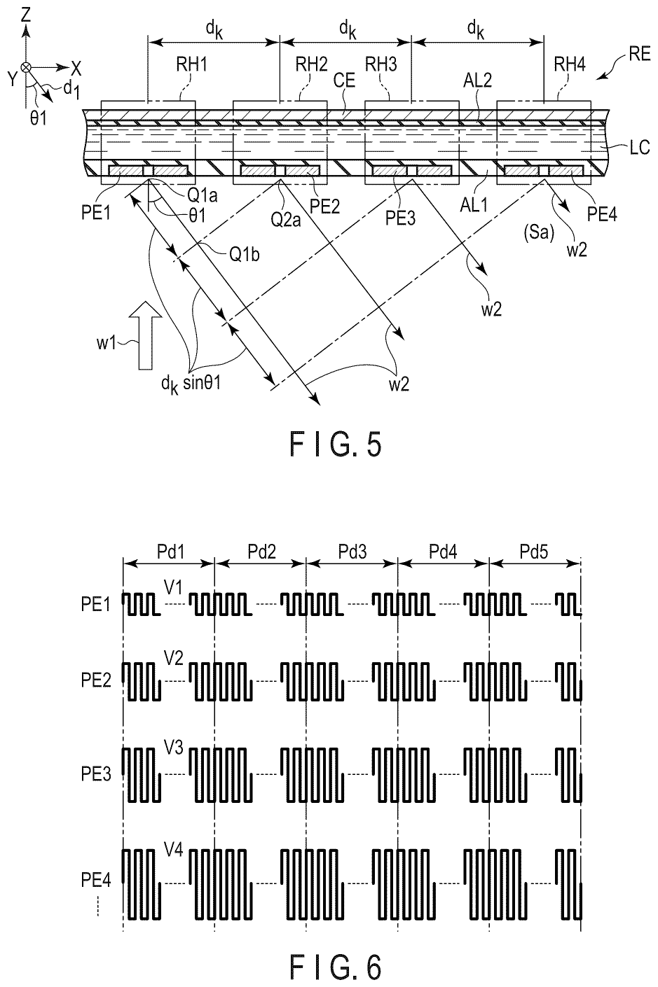

FIG. 5 is an enlarged cross-sectional view showing a part of the intelligent reflecting surface RE, illustrating a plurality of reflection controllers RH. In FIG. 5, illustration of the substrate 1, the spacers SS, and the like is omitted.

As shown in FIG. 5, each reflection controller RH functions to adjust the phase of the radio wave (incident wave w1) made incident from the incident surface Sa side according to the voltage applied to the patch electrode PE, and urge the radio wave to be reflected to the incident surface Sa side as the reflected wave w2. In each reflection controller RH, the reflected wave w2 is a synthetic wave of the radio wave reflected on the patch electrode PE and the radio wave reflected on the common electrode CE.

The patch electrodes PE are arranged at regular intervals in the direction along the X-axis. A length (pitch) between adjacent patch electrodes PE is referred to as dₖ. The length dₖ corresponds to a distance from a geometric center of one patch electrode PE to a geometric center of the adjacent patch electrode PE. In the embodiment, it is assumed that the reflected waves w2 have the same phase in the first reflection direction dₗ. On the X-Z plane of FIG. 5, the first reflection direction dₗ is a direction forming a first angle θ1 with the Z axis. The first reflection direction dₗ is parallel to the X-Z plane.

In order for the phases of the radio waves reflected on the plurality of reflection controllers RH to be aligned in the first reflection direction dₗ, the phases of the radio waves need only be aligned on the linear two-dot chain line. For example, the phase of the reflected wave w2 at point Q1b and the phase of the reflected wave w2 at point Q2a may be aligned. A physical linear distance from point Q1a to point Q1b of the first patch electrode PE1 is dₖ×sin θ1. Therefore, when the first reflection controller RH1 and the second reflection controller RH2 are focused, the phase of the reflected wave w2 from the second reflection controller RH2 may be delayed from the phase of the reflected wave w2 from the first reflection control section RH1 by a phase amount δ1. The phase amount δ1 is represented by the following equation.

δ1=dₖ×sin θ1×2π/λ

Next, a method of driving the intelligent reflecting surface RE will be described. FIG. 6 is a timing chart showing changes in the voltages applied to the patch electrodes PE for each period in the method of driving the intelligent reflecting surface RE of the embodiment. FIG. 6 shows a first period Pd1 to a fifth period Pd5 of the driving periods of the intelligent reflecting surface RE.

As shown in FIG. 5 and FIG. 6, when driving the intelligent reflecting surface RE is started, voltages V are applied to a plurality of patch electrodes PE such that the radio waves reflected on the plurality of reflection controllers RH have the same phase in the first reflection direction dₗ during the first period Pd1. For example, a first voltage V1 is applied to the first patch electrode PE1, a second voltage V2 is applied to the second patch electrode PE2, a third voltage V3 is applied to the third patch electrode PE3, and a fourth voltage V4 is applied to the fourth patch electrode PE4. An absolute value of the voltage V applied to each patch electrode PE is the same over the entire period Pd.

When the potential of the common electrode CE is referred to as a reference, the polarity of the voltage applied to each patch electrode PE is periodically reversed. For example, the patch electrode PE is driven with a drive frequency of 60 Hz. As described above, the patch electrodes PE are AC-driven.

Even if the period Pd changes to another period Pd, the phase amount δ1 of the radio waves reflected in the first reflection direction dₗ by one reflection controller RH and the radio waves reflected in the first reflection direction dₗ by the adjacent reflection controller RH is maintained. In the embodiment, the phase amount δ1 is 35°. For this reason, a phase difference of 245° is assigned between the radio waves reflected in the first reflection direction dₗ by the first reflection controller RH1 including the first patch electrode PE1 and the radio waves reflected in the first reflection direction dₗ by the eighth reflection controller RH8 including the eighth patch electrode PE8.

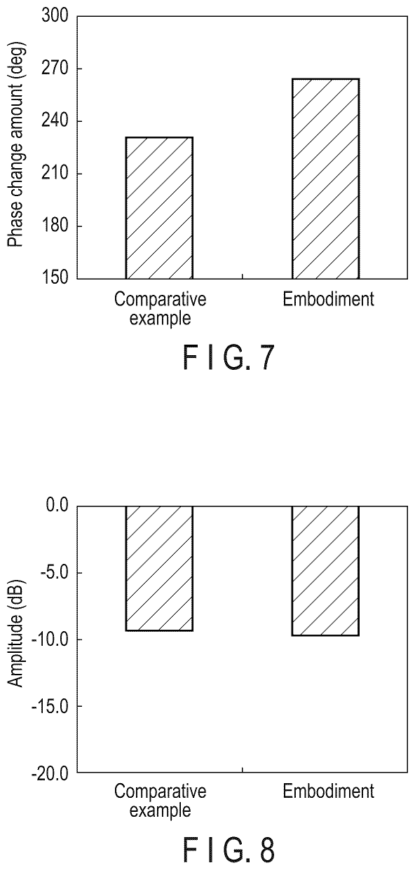

Next, the characteristics of the reflected wave w2 of the intelligent reflecting surface RE of the embodiment and the characteristics of a reflected wave of an intelligent reflecting surface of a comparative example will be compared and described. FIG. 7 is a bar graph showing phase change amounts of the reflected waves in the embodiment and the comparative example. FIG. 8 is a bar graph showing attenuations of the reflected waves in the embodiment and the comparative example. The intelligent reflecting surface of the comparative example is configured similarly to the intelligent reflecting surface RE of the embodiment, except that the patch electrodes PE are formed without the first apertures O1.

In order to obtain the phase change amounts of the reflected waves and the attenuations of the reflected waves, the parameters of the intelligent reflecting surface RE of the embodiment and the parameters of the intelligent reflecting surface of the comparative example are set as shown below in Table 1.

TABLE 1

| | | | Comparative | |
|---|---|---|---|---|
| | Embodiment | | example | |
| Size of patch electrode | Px = Py = 35 mm | | Px = Py = 35 mm | |
| (Px × Py) | | | | |
| Size of first aperture | Ox = Oy = 300 μm | | None | |
| (Ox × Oy) | | | | |
| Thickness of liquid crystal | 50 | μm | 50 | μm |
| layer (d₁) | | | | |
| Frequency rangeof incident wave | 2.4 | GHZ | 2.4 | GHz |

It can be understood that as shown in FIG. 7, the phase change amount of the reflected wave in the embodiment in which the aperture (first aperture O1) is formed in the patch electrode PE is greater than that in the comparative example in which the aperture is not formed in the patch electrode PE. For this reason, improvement of the degree of freedom in phase control of the reflected wave can be attempted in the intelligent reflecting surface RE of the embodiment. For example, the reflection direction of the reflected wave w2 can be further tilted from the Z-axis (the angle θ can be increased). In addition, when the phase amount of the reflected wave is set to be the same in the embodiment and the comparative example, the absolute value of the voltage applied between the patch electrode PE and the common electrode CE in the embodiment can be set to be lower than the absolute value of the voltage applied between the patch electrode PE and the common electrode CE in the comparative example.

The phase change amount of the reflected wave is a difference between the minimum phase amount of the reflected wave and the maximum phase amount of the reflected wave. Next, table 2 shows the minimum phase amount δmin of the reflected wave, the absolute value (Vmin) of the voltage applied between the patch electrode PE and the common electrode CE when the phase amount of the reflected wave is the minimum (6 min), the maximum phase amount δmax of the reflected wave, and the absolute value (Vmax) of the voltage applied between the patch electrode PE and the common electrode CE when the phase amount of the reflected wave is the maximum (δmax). When the absolute value of the voltage exceeds a threshold value, the phase amount of the reflected wave is saturated. Although the phase amount (δmax) can be obtained in a wide range of the voltage value, Table 2 shows the absolute value (Vmax) of the voltage as an example of the voltage from which the phase amount (δmax) can be obtained.

TABLE 2

| | | Comparative |
|---|---|---|
| | Embodiment | example |
| Absolute value of voltage (V min) | 0 V | 0 V |
| Minimum phase amount | 0° | 0° |
| of reflected wave ( δ min) | | |
| Absolute value of voltage (V max) | 10 V | 10 V |
| Maximum phase amount | 265° | 231° |
| of reflected wave ( δ max) | | |

As shown in FIG. 4, in comparison to the comparative example, targets for driving the liquid crystal layer LC are reduced by the content of the first area A1 of the liquid crystal layer LC, in the embodiment.

As shown in FIG. 8, however, it can be understood that the attenuation of the amplitude of the reflected wave in the embodiment is suppressed and becomes equivalent to the attenuation of the amplitude of the reflected wave in the comparative example. The amplitude in a case where the radio wave is totally reflected on the intelligent reflecting surface RE is 0 dB. FIG. 8 shows a case where the attenuation of the amplitude of the reflected wave is maximum. Next, Table 3 shows the absolute value (V) of the voltage applied between the patch electrode PE and the common electrode CE, and the phase amount (δ) of the reflected wave in a case where the attenuation of the amplitude of the reflected wave is maximum.

TABLE 3

| | | Comparative |
|---|---|---|
| | Embodiment | example |
| Attenuation of amplitude of reflected wave | Maximum | Maximum |
| Absolute value of voltage (V) | 5 V | 5 V |
| Phase amount of reflected wave (δ) | 120° | 120° |

By providing the aperture (first aperture O1) in the patch electrode PE, as is clear from FIGS. 7 and 8, the intelligent reflecting surface RE of the embodiment can increase the phase change amount of the reflected wave to be more than that of the comparative example while suppressing the reduction in the reflection efficiency of the radio wave to be equivalent to that of the comparative example.

According to the intelligent reflecting surface RE of one embodiment configured as described above, each patch electrode PE includes the first aperture O1. When the voltage level applied between the patch electrode PE and the common electrode CE is changed, the phase change amount of the reflected wave w2 can be increased. From the above, the intelligent reflecting surface RE capable of increasing the phase change amount of the reflected wave w2 of the radio wave can be obtained.

Since the radio wave of 28 GHz range used in have a strong straightness, the communication environment is deteriorated when a shield exists (coverage hole). For this reason, the reflected wave w2 can be used by arranging the intelligent reflecting surface RE as a measure. Since the intelligent reflecting surface RE can control the direction of the reflected wave w2, it can respond to changes in the radio wave environment.

### Modified Example 1 of the Embodiment

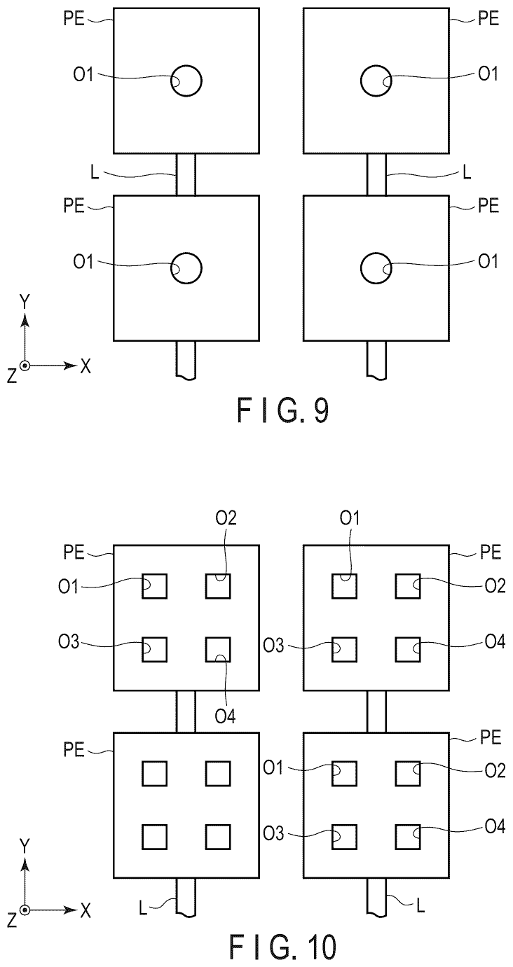

Next, modified example 1 of the above embodiment will be described. FIG. 9 is an enlarged plan view showing a plurality of patch electrodes PE and a plurality of connection wires L according to modified example 1 of the embodiment.

As shown in FIG. 9, the intelligent reflecting surface RE of modified example 1 is different from the above-described embodiment in terms of the shape of the first aperture O1. The first aperture O1 has a shape of a circle (perfect circle). Although the shape of the first aperture O1 is not particularly limited, a square or a perfect circle is desirable. When the outline of the first aperture O1 is focused, it is preferable that the direction of polarization of the incident radio wave, more specifically, making the same behavior for vertically polarized wave and horizontally polarized wave is preferable, and the shape in which the vertical and horizontal aspect ratio is 1:1 is desirable.

### Modified Example 2 of the Embodiment

Next, modified example 2 of the above embodiment will be described. FIG. 10 is an enlarged plan view showing patch electrodes PE and a plurality of connection wires L according to modified example 2 of the embodiment.

As shown in FIG. 10, each patch electrode PE may include a plurality of apertures. The patch electrode PE further includes a second aperture O2 located separately from the first aperture O1, a third aperture O3 located separately from the first aperture O1 and the second aperture O2, and a fourth aperture O4 located separately from the first aperture O1, the second aperture O2, and the third aperture O3. The size and shape of the first aperture O1 are the same among the plurality of patch electrodes PE. The size and shape of the second aperture O2 are the same among the plurality of patch electrodes PE. The size and shape of the third aperture O3 are the same among the plurality of patch electrodes PE. The size and shape of the fourth aperture O4 are the same among the plurality of patch electrodes PE.

A relative position of the first aperture O1 in the patch electrode PE is the same among the plurality of patch electrodes PE. A relative position of the second aperture O2 in the patch electrode PE is the same among the plurality of patch electrodes PE. A relative position of the third aperture O3 in the patch electrode PE is the same among the plurality of patch electrodes PE. A relative position of the fourth aperture O4 in the patch electrode PE is the same among the plurality of patch electrodes PE.

The number of apertures O included in the patch electrode PE may be two, three, or five or more.

### Modified Example 3 of the Embodiment

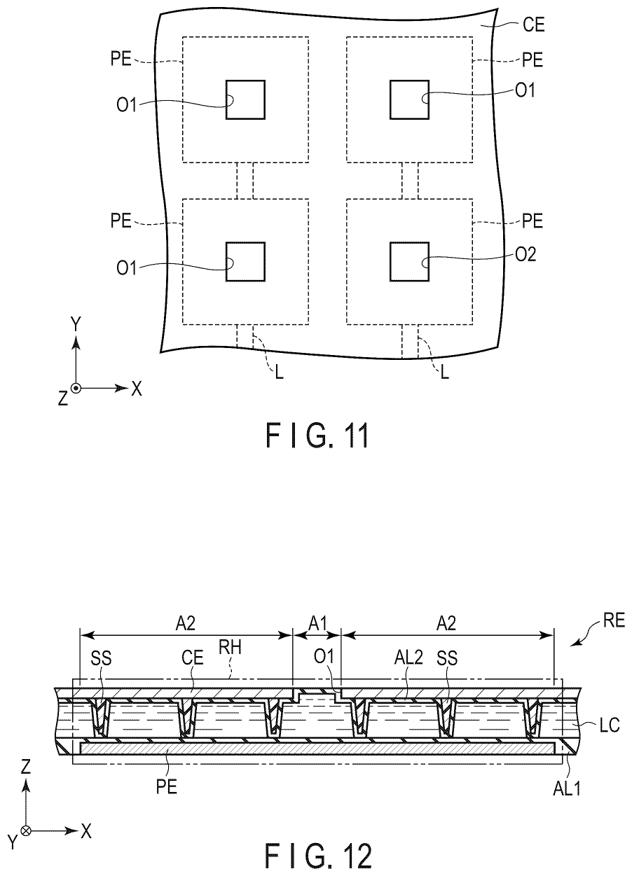

Next, modified example 3 of the above embodiment will be described. FIG. 11 is an enlarged plan view showing a part of the intelligent reflecting surface RE according to modified example 3, illustrating a plurality of patch electrodes PE, a plurality of connection wires L, and a common electrode CE. FIG. 12 is an enlarged cross-sectional view showing a part of the intelligent reflecting surface RE according to modified example 3, illustrating a single reflection controller RH.

As shown in FIG. 11, modified example 3 is different from the above embodiment in that not the patch electrode PE, but the common electrode CE includes a hole referred to as a aperture. The common electrode CE includes a plurality of first apertures O1. Each first aperture O1 overlaps with one corresponding patch electrode PE among the plurality of patch electrodes PE.

As shown in FIG. 12, no spacer SS exists in the area opposed to the first aperture O1, in modified example 3. However, the spacer SS may exist in the area opposed to the first aperture O1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An intelligent reflecting surface comprising:
a first substrate including a plurality of patch electrodes spaced apart and arranged in a matrix along each of an X-axis and a Y-axis orthogonal to each other;
a second substrate including a common electrode opposed to the plurality of patch electrodes in a direction parallel to a Z-axis orthogonal to each of the X-axis and the Y-axis; and
a liquid crystal layer held between the first substrate and the second substrate and opposed to the plurality of patch electrodes,
each of the patch electrodes including a first aperture.

2. The intelligent reflecting surface of claim 1, wherein
a size and a shape of the first aperture are the same among the plurality of patch electrodes, and
a relative position of the first aperture in the patch electrode is the same among the plurality of patch electrodes.

3. The intelligent reflecting surface of claim 1, wherein
each of the patch electrodes further includes a second aperture located to be separated from the first aperture.

4. The intelligent reflecting surface of claim 3, wherein
a size and a shape of the first aperture are the same among the plurality of patch electrodes,
a size and a shape of the second aperture are the same among the plurality of patch electrodes,
a relative position of the first aperture in the patch electrode is the same among the plurality of patch electrodes, and
a relative position of the second aperture in the patch electrode is the same among the plurality of patch electrodes.

5. The intelligent reflecting surface of claim 1, wherein
each of reflection controllers includes one patch electrode among the plurality of patch electrodes, a portion of the common electrode, which is opposed to the one patch electrode, a first area of the liquid crystal layer, which is opposed to the first aperture of the one patch electrode, and a second area of the liquid crystal layer, which is an area opposed to the one patch electrode and which is an area surrounding the first area,
the first substrate has an incident surface on a side opposite to a side opposed to the second substrate, and
each of the reflection controllers adjusts a phase of a radio wave made incident from the incident surface side in accordance with a voltage applied to the patch electrode, and reflects the radio wave to the incident surface side.

6. The intelligent reflecting surface of claim 5, wherein
in a state in which no voltage is applied between the one patch electrode and the common electrode, a dielectric constant of the first area is the same as a dielectric constant of the second area, and
in a state in which a voltage is applied between the one patch electrode and the common electrode, the dielectric constant of the first area is different from the dielectric constant of the second area.

7. An intelligent reflecting surface comprising:
a first substrate including a plurality of patch electrodes spaced apart and arranged in a matrix along each of an X-axis and a Y-axis orthogonal to each other;
a second substrate including a common electrode opposed to the plurality of patch electrodes in a direction parallel to a Z-axis orthogonal to each of the X-axis and the Y-axis; and
a liquid crystal layer held between the first substrate and the second substrate and opposed to the plurality of patch electrodes,
the common electrode including a plurality of first apertures,
each of the first apertures overlapping with one corresponding patch electrode among the plurality of patch electrodes.
